(19) United States
(12) Patent Application Publication
(10) Pub. No.: US 2008/0115175 A1
(43) Pub. Date: May 15, 2008

(54) SYSTEM AND METHOD FOR SIGNALING CHARACTERISTICS OF PICTURES' INTERDEPENDENCIES

(76) Inventor: Arturo A. Rodriguez, Norcross, GA (US)

Correspondence Address: SCIENTIFIC-ATLANTA, INC.;INTELLECTUAL PROPERTY DEPARTMENT, 5030 SUGARLOAF PARKWAY, LAWRENCEVILLE, GA, 30044, US

(21) Appl. No.: 11/627,452

(22) Filed: Jan. 26, 2007

Related U.S. Application Data
(60) Provisional application No. 60/865,644, filed on Nov. 13, 2006.

(51) Int. Cl. H04N 7/173

(52) U.S. Cl. 725/87

(57) ABSTRACT

Disclosed are systems and methods for signaling characteristics of picture interdependencies in a video signal in subscriber television systems. In this regard, a representative method comprises allocating auxiliary information at a transport layer of a video program as to determine whether a picture is one of the following: discardable picture, forward predicted picture, a backward predicted picture, and a bi-directional predicted picture. The auxiliary information at the transport layer is generally unencrypted and transmitted as part of private data or an adaptation field. The auxiliary information enables a video decoder to determine whether to drop the picture corresponding to the auxiliary information without having to parse a video stream.

### CROSS-REFERENCE TO RELATED APPLICATION

This application claims the benefit of copending U.S. provisional application entitled, “SYSTEM AND METHOD FOR SIGNALING CHARACTERISTICS OF PICTURES' INTERDEPENDENCIES,” having Ser. No. 60/865,644, filed on Nov. 13, 2006, which is entirely incorporated herein by reference.

### TECHNICAL FIELD

The present disclosure is generally related to processing video streams, and, more particularly, is related to signaling characteristics of pictures' interdependencies in subscriber television systems.

### BACKGROUND

In implementing enhanced programming in subscriber television systems, the digital home communication terminal (“DHCT”), otherwise known as the set-top box, can support an increasing number of two-way digital services such as, for example, video-on-demand and personal video recording (PVR).

Typically, a DHCT is connected to a subscriber television system, such as, for example, a cable or satellite network, and includes hardware and software necessary to provide the functionality of the digital television system at the user's site. Some of the software executed by a DHCT may be downloaded and/or updated via the subscriber television system. Each DHCT also typically includes a processor, communication components, and memory, and is connected to a television or other display device, such as, for example, a personal computer. While many conventional DHCTs are stand-alone devices that are externally connected to a television, a DHCT and/or its functionality may be integrated into a television or personal computer or even an audio device such as, for example, a programmable music player, as will be appreciated by those of ordinary skill in the art.

One of the features of the DHCT includes the ability to receive and decode a digital video signal as a compressed video signal. Another feature of the DHCT includes providing Personal Video Recorder (PVR) functionality through the use of a storage device coupled to the DHCT. When providing this PVR functionality or other stream manipulation functionality for formatted digital video streams of Advanced Video Coding (AVC), referred to herein as AVC streams, it becomes difficult to determine whether the video stream is suitable for a particular stream manipulation or PVR operation. This is because, for example, the AVC video coding standard generally has a rich set of compression tools and can exploit temporal redundancies among pictures in more elaborate and comprehensive ways than prior video coding standards.

AVC can potentially yield superior video compression. For example, AVC compression is generally accompanied with higher complexities in pictures' interdepencies that make it difficult to fulfill stream manipulation and PVR operations. To mitigate these complexities, among others, there is a need to communicate explicit information about the pictures' interdependencies in the video stream to provision stream manipulation and PVR functionality.

### BRIEF DESCRIPTION OF THE DRAWINGS

The embodiments of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a high-level block diagram depicting an example subscriber television system, in accordance with one embodiment of the disclosure;

FIG. 2 is a block diagram of an exemplary digital home communication terminal (DHCT) as depicted in FIG. 1 and related equipment, in accordance with one embodiment of the disclosure;

FIG. 3 is an exemplary diagram illustrating a transport stream generation;

FIG. 4 is an exemplary diagram illustrating a transport packet structure; and

FIG. 5 is an exemplary flow diagram illustrating a process for signaling characteristics of pictures' interdependencies (COPID) in a video signal in subscriber television systems.

### DETAILED DESCRIPTION

A description of the MPEG-2 Video Coding standard can be found in the following publication, which is hereby incorporated by reference: (1) ISO/IEC 13818-2, (2000), “Information Technology—Generic coding of moving pictures and associated audio—Video.” A description of the AVC video coding standard can be found in the following publication, which is hereby entirely incorporated by reference: ITU-T Rec. H.264|ISO/IEC 14496-10, (2005), “Information Technology—Coding of audio visual objects—Part 10: Advanced Video Coding.” A description of MPEG-2 Systems for transporting AVC video streams can be found in the following publications, which are hereby entirely incorporated by reference: (1) ISO/IEC 13818-1, (2000), “Information Technology—Generic coding of moving pictures and associated audio—Part 1: Systems,” and (2) ITU-T Rec. H.222.0|ISO/IEC 13818-1:2000/AMD.3, (2004), “Transport of AVC video data over ITU-T Rec. H222.0|ISO/IEC 13818-1 streams.”

Disclosed herein are systems and methods for signaling the characteristics of pictures' interdependencies (COPID) in a video signal in subscriber television systems. It is noted that “picture” is used throughout this disclosure as one picture from a sequence of pictures that constitutes video, or digital video, in one of a plurality of forms. Furthermore, throughout this disclosure, the terms “compression format” and “video compression format” have the same meaning. Throughout the disclosure, video programs should be understood to include television programs, movies, or provided video signals such as, for example, those provided by a personal video camera. Such video programs comprise of signals and/or compressed data streams corresponding to an ensemble of one or more sequence of elements that include video, audio, and/or other data, multiplexed and packetized into a transport stream, such as, for example, MPEG-2 Transport. The disclosed embodiments may be embodied in many different forms and should not be construed as limited to the embodiments set forth herein; rather, these embodiments are provided so that this disclosure will be thorough and complete, and will fully convey the scope of the disclosure to those having ordinary skill in the art. Furthermore, all “examples” given herein are intended to be non-limiting, and are provided as an exemplary list among other examples contemplated but not shown.

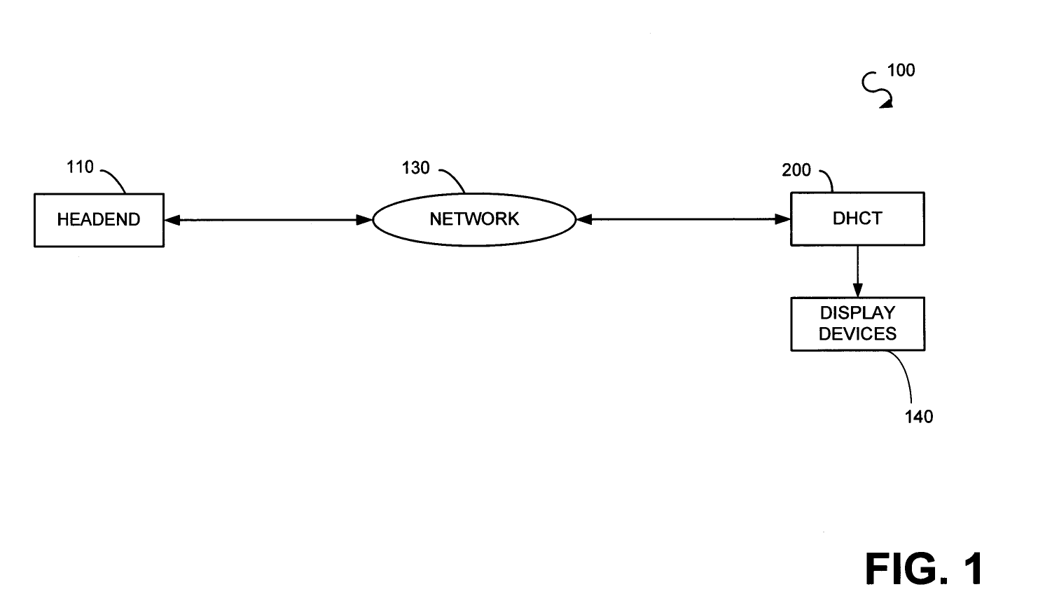

FIG. 1 is a block diagram that depicts an example subscriber television system (STS) 100. In this example, the STS 100 includes a headend 110 and a DHCT 200 that are coupled via a network 130. The DHCT 200 is typically situated at a user's residence or place of business and may be a stand-alone unit or integrated into another device such as, for example, a display device 140 or a personal computer (not shown), among other devices. The DHCT 200 receives signals (video, audio and/or other data) including, for example, digital video signals in a compressed representation of a digitized video signal such as, for example, compressed AVC streams modulated on a carrier signal, and/or analog information modulated on a carrier signal, among others, from the headend 110 through the network 130, and provides reverse information to the headend 110 through the network 130.

The network 130 may include any suitable medium for communicating television service data including, for example, a cable television network or a satellite television network, among others. The headend 110 may include one or more server devices (not shown) for providing video, audio, and textual data to client devices such as, for example, the DHCT 200. The headend 110 and the DHCT 200 cooperate to provide a user with television services including, for example, television programs, an interactive program guide (IPG), and/or video-on-demand (VOD) presentations, among others. The television services are presented via the display device 140, which is typically a television set that, according to its type, is driven with an interlaced scan video signal or a progressive scan video signal. However, the display device 140 may also be any other device capable of displaying video images including, for example, a computer monitor. Although shown communicating with a display device 140, the DHCT 200 can communicate with other devices that receive and store and/or process the signals from the DHCT 200.

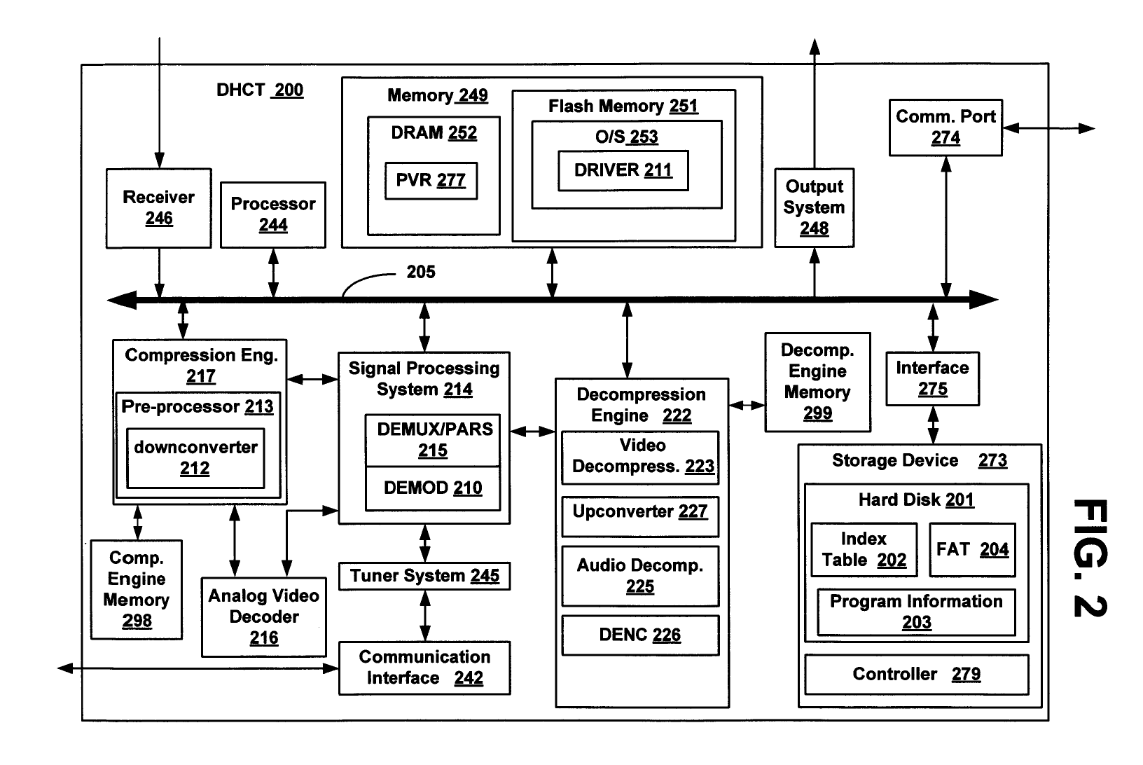

FIG. 2 is a block diagram that illustrates selected components of a DHCT 200, in accordance with one embodiment of the present disclosure. It will be understood that the DHCT 200 shown in FIG. 2 is merely illustrative and should not be construed as implying any limitations upon the scope of the disclosure. For example, in another embodiment, the DHCT 200 may have fewer, additional, and/or different components than the components illustrated in FIG. 2. A DHCT 200 is generally situated at a user's residence or place of business and may be a stand alone unit or integrated into another device such as, for example, a television set or a personal computer. The DHCT 200 preferably includes a communications interface 242 for receiving signals (video, audio and/or other data) from the headend 110 (FIG. 1) through the network 130 (FIG. 1), and provides reverse information to the headend 110.

The DHCT 200 may further include at least one processor 244 for controlling operations of the DHCT 200, an output system 248 for driving the television display 140 (FIG. 1), and a tuner system 245 for tuning to a particular television channel and/or frequency and for sending and receiving various types of data to/from the headend 110 (FIG. 1). The DHCT 200 may include, in other embodiments, multiple tuners for receiving downloaded (or transmitted) data. The tuner system 245 can select from a plurality of transmission signals provided by the subscriber television system 100 (FIG. 1). The tuner system 245 enables the DHCT 200 to tune to downstream media and data transmissions, thereby allowing a user to receive digital and/or analog media content via the subscriber television system 100. The tuner system 245 includes, in one implementation, an out-of-band tuner for bi-directional quadrature phase shift keying (QPSK) data communication and one or more quadrature amplitude modulation (QAM) tuners (in band) for receiving television signals. Additionally, a receiver 246 receives externally-generated user inputs or commands from an input device such as, for example, a remote control device (not shown).

The DHCT 200 may include one or more wireless or wired interfaces, also called communication ports 274, for receiving and/or transmitting data to other devices. For instance, the DHCT 200 may feature USB (Universal Serial Bus), Ethernet, IEEE-1394, serial, and/or parallel ports, etc. The DHCT 200 may also include an analog video input port for receiving analog video signals. User input may be provided via an input device such as, for example, a hand-held remote control device or a keyboard.

The DHCT 200 includes a signal processing system 214, which comprises a demodulating system 210 and a transport demultiplexing and parsing system 215 (herein demultiplexing system) for processing broadcast media content and/or data. One or more of the components of the signal processing system 214 can be implemented with software, a combination of software and hardware, or simply in hardware. The demodulating system 210 comprises functionality for demodulating analog or digital transmission signals.

A compression engine can reside at headend 110 or in DHCT 200 or elsewhere. A compression engine can receive a digitized uncompressed TV signal, such as, for example, one provided by analog video decoder 216, in one implementation. Digitized pictures and respective audio output by the analog video decoder 216 are presented at the input of a compression engine 217, which can be an AVC video or an MPEG-2 video compression engine.

In the foregoing description, compression engine 217 can include a compression engine with similar AVC video or MPEG-2 video compression capabilities located at headend 110 or elsewhere. The disclosed methods and systems are capable of providing signaling of the COPID in a video signal in subscriber television systems at the transport level, rather than at the video stream level, such as, for example, information corresponding to the COPID of the video stream, such as, for example, an AVC stream. The U.S. provisional application No. 60/395,969, filed on Jul. 15, 2002, discloses information related to compression technology, and, more particularly, related to upconversion of chroma signal information in subscriber television systems. The '969 provisional application is entirely incorporated herein by reference.

The compressed video and audio streams are produced in accordance with the syntax and semantics of a designated audio and video coding method, such as, for example, MPEG-2 or AVC, so that the compressed video and audio streams can be interpreted by the decompression engine 222 for decompression and reconstruction at a future time. Each AVC stream is packetized into transport packets according to the syntax and semantics of transport specification, such as, for example, MPEG-2 Transport defined in MPEG-2 Systems. Each transport packet contains a header with a unique packet identification code, or PID, associated with the respective AVC stream.

The demultiplexing system 215 can include MPEG-2 transport demultiplexing capabilities. When tuned to carrier frequencies carrying a digital transmission signal, the demultiplexing system 215 enables the separation of packets of data, corresponding to the desired AVC stream, for further processing. Concurrently, the demultiplexing system 215 precludes further processing of packets in the multiplexed transport stream that are irrelevant or not desired, such as packets of data corresponding to other video streams. Parsing capabilities of the demultiplexing system 215 allow for the ingesting by DHCT 200 of program associated information carried in the transport packets, such as, for example, information corresponding to the characteristics of the interdependencies among the pictures of the AVC stream. The signaling of the COPID can be accomplished by specifying explicit information in the private data section of the adaptation data of a transport stream packet, such as that of MPEG-2 Transport. By specification of this information, it should be understood to practitioners in the field that the “carriage” or the “signaling” of such information can correspond to the video program's multiplex at the transport layer (rather than in the video layer). The COPID can be carried as unencrypted data in the video program (e.g., the multiplex of the streams associated with the video program) via, for example, navigation to private data in the adaptation field of MPEG-2 Transport.

The components of the signal processing system 214 are generally capable of QAM demodulation, forward error correction, demultiplexing of MPEG-2 transport streams, and parsing of packets and streams. Stream parsing may include parsing of packetized elementary streams or elementary streams. Packet parsing includes parsing and processing of fields that deliver explicit information corresponding to the COPID of the AVC stream. The signal processing system 214 further communicates with the processor 244 via interrupt and messaging capabilities of the DHCT 200. The processor 244 annotates the location of pictures within the compressed stream as well as other pertinent information corresponding to COPID of the AVC stream. Alternatively or additionally, the annotations may be according to or derived from the COPID of the AVC stream. The annotations by the processor 244 enable normal playback as well as other playback modes of the stored instance of the video program. Other playback modes, often referred to as “trick modes,” may comprise backward or reverse playback, forward playback, or pause or still. The playback modes may comprise one or more playback speeds other than the normal playback speed. Some playback speeds may be slower than normal speed and other may be faster. Faster playback speeds may constitute speeds considered very fast (e.g., greater than three times normal playback speed), as determined by a threshold, and critical faster speeds (e.g., greater than normal playback speed but not above the threshold). The threshold can be referred to as the critical fast speed threshold.

In some embodiments, the COPID in the AVC stream are provided to the decompression engine 222 by the processor 244. In another embodiment, the annotations stored in the storage device are provided to the decompression engine 222 by the processor 244 during playback of a trick mode. In yet another embodiment, the COPID or annotations are only provided during a trick mode, wherein the processor 244 has programmed the decompression engine 222 to perform trick modes.

For a video-on-demand (VOD) service, wherein a dedicated transmission of a movie or video program is transmitted from a VOD server in the headend 110 to the DHCT 200, the COPID in the AVC stream are only transmitted to the DHCT 200 when a trick mode is in effect. The decompression engine 222 may determined that a trick mode is in effect by detecting “low delay” signaling, allowing the bit-buffer, where the incoming compressed AVC stream is deposited (in memory 299), to underflow. Low delay signaling causes the decompression engine 222 to: (1) not start decompressing a compressed picture until it is completely deposited in the bit buffer, and (2) to display the previous decompressed picture repeatedly (rather than generate an error condition) until the next one is completely decompressed and reconstructed.

The packetized compressed streams can also be outputted by the signal processing system 214 and presented as input to the decompression engine 222 for audio and/or video decompression. The signal processing system 214 may include other components (not shown), including memory, decryptors, samplers, digitizers (e.g., analog-to-digital converters), and multiplexers, among others. The demultiplexing system 215 parses (e.g., reads and interprets) transport packets, and deposits the information corresponding to the COPID of the AVC stream (e.g., payload of the transport packet's private data) into DRAM 252.

Upon effecting the demultiplexing and parsing of the transport stream, the processor 244 interprets the data output by the signal processing system 214 and generates ancillary data in the form of a table or data structure (index table 202) comprising the relative or absolute location of the beginning of certain pictures in the compressed video stream. The processor 244 also processes the information corresponding to the COPID to make annotations for PVR operations. The annotations, or ancillary data, are stored in the storage device by the processor 244. Such ancillary data is used to facilitate the retrieval of desired video data during future PVR operations. In some embodiments, during a VOD service or a non-PVR operation, the processor 244 only processes the information corresponding to the COPID when a trick mode is in effect.

The demultiplexing system 215 can parse the received transport stream (or the stream generated by the compression engine 217) without disturbing its content and deposit the parsed transport stream into the DRAM 252. The processor 244 can generate the annotations and ancillary information even if the video program is encrypted because the COPID in the AVC stream are carried unencrypted. The processor 244 causes the transport stream in DRAM 252 to be transferred to a storage device 273. Additional relevant security, authorization and/or encryption information may be stored. Alternatively or additionally, the information corresponding to the COPID of the AVC stream may in the form of a table or data structure comprising the interdependencies among the pictures.

A first characteristic may be specified by the value of a data field such as a bit, dyad (two bits), nibble or byte. The value of the field can provide deterministic inference of the corresponding characteristic. A first field value for the data field may correspond to “unspecified,” wherein no information is signaled about the first characteristic. A second value for the data field may specify an extension for future value for the characteristic. For example, if the data field is a nibble, the characteristic may have 14 different values, the 15^{th} value for unspecified, and the 16^{th} value for extension (referred to as reserved). Means for more than 14 different values for the first characteristic become possible via the expansion value, allowing more data corresponding to the first characteristic to be read (as expressed by parsing logic of the syntax defining the information corresponding to the COPID).

The presence of the specification of a second set of COPID may be specified by a data field such a bit, dyad (dual bits), or nibble, or any other compact data representation that signals whether the pertinent information describing the value of the second characteristic is included. Hence, this type of data field specifies the presence or absence of information. This type of information may be a dyad that can specify one of 14 possible values, one corresponding to “unspecified,” in which case the characteristic is not specified. Another value may be used to specify reserved for future expansion. The two remaining values may be used to specify the second characteristic in a first format and a second format. For instance, the I (Intra) picture repetition period in the picture sequence may be specified in terms of time (a first value) or in terms of number of pictures (the second value). For example, if the two-bit field equals 0, the I picture repetition period is not specified within the overall set of information corresponding to the COPID. If the field equals 1, there is an additional data element included that specifies the value of the I picture repetition period, such as, for example, in terms of time in 0.5 second increments. If the field equals 2, there is an additional data element included that specifies the value of the I picture repetition period in terms of number of pictures in N picture increments.

Information in COPID includes characteristics about types of repeating picture patterns, including one or more of the following:
1. The I or IDR (instantaneous decoder refresh) repetition period, considered defining the demarcation of a longer repeating sequence of pictures.
2. The repetition period of forward predicted pictures with respect to one of the defined repeating sequences of pictures.
3. The repetition period of backward predicted pictures with respect to one of the defined repeating sequences of pictures.
4. The relationship of a defined shorter repeating sequence of pictures to the defined longer repeating sequence of pictures. For instance, there may be four shorter repeating sequences of pictures accommodated to span the longer repeating sequence of pictures, where the first picture of the first instance of the shorter repeating sequence may be the same type of picture as the first picture of the longer repeating sequence of pictures; or the first picture of the first instance of the shorter repeating sequence is replaced by the type of picture in the first picture of the longer repeating sequence of pictures (e.g., an I picture or an IDR picture replaces a forward predicted picture). A third repeating sequence of pictures, shorter than the shorter repeating sequence of pictures, can be specified if necessary.

A bitmap in COPID can serve to indicate which respective picture in the shorter repeating sequence of pictures is a reference picture or a non-reference picture. A non-reference picture is deemed discardable (e.g., no other picture depends on the non-reference picture for reconstruction). Alternatively or additionally, the bitmap can be used for the longer repeating sequence of pictures. Alternatively or additionally, the bits of the bitmap correspond to the respective pictures in their transmission order (e.g., the decode order). Alternatively or additionally, the bits of the bitmap correspond to the display order of the pictures.

Information in COPID can include a picture type that conveys the picture interdependency characteristic useful for traversing a stream for trick modes. For each picture in the shorter sequence of pictures, information useful to traverse the stream for forward or backward playback is provided. Pictures not in the desired order can be dropped. The information in COPID can include the following:
1. I or IDR, independent of other previously reconstructed pictures;
2. Forward predicted picture (FPP), which is either a P picture or a B picture in AVC, and depends for its reconstruction only on one or more previously reconstructed pictures, each with an earlier presentation time (e.g., display time);
3. Backward predicted picture (BPP), which is either a P picture or a B picture in AVC, and depends for its reconstruction only on one or more previously reconstructed pictures with a future presentation time; and
4. Bi-directional predicted picture (also either a P or B picture), which can be skipped over while traversing the compressed AVC stream to implement trick modes.

Alternatively or additionally, an FPP is classified as a pure FPP if it has no indirect backward prediction. That is, its ancestors, the chain of reference picture dependencies from the picture that the FPP depends on, have no backward prediction. An FPP can be defined as a first-level FPP, a second-level FPP, and so forth. The level expresses the depth of ancestors guaranteed to have no backward prediction. A BPP can be defined similarly with a pure BPP having ancestors without forward prediction and levels.

Alternatively or additionally, only pure FPPs and pure BPPs can be specified. Alternatively or additionally, the COPID can specify that the FPPs adhere to being at least n-level FPPs, and that the BPPs adhere to being at least an m-level BPP.

Another type of picture characteristic is the number of reference pictures in which a picture depends on for reconstruction. A first data field and second data field for each picture in a repeating sequence can be specified. The first data field specifies the number of past reference pictures (e.g., pictures with an earlier presentation time), and the second data field specifies the number of future reference pictures (e.g., pictures with a later presentation time). The I and IDR pictures do not have dependencies on other pictures for reconstruction so both fields would be zero. If the number of dependent pictures is over a threshold, a maximum value may be expressed as an indication of not being sufficiently low.

Another type of picture characteristic is the explicit specification of which pictures a picture depends on for its reconstructions. The location of pictures are identified according to their relative location in the shorter repeating sequences of pictures (either in transmission order or display order). A dependency tree can be defined by:
1. specifying the total number of pictures, K, in the repeating sequence of pictures,
2. specifying a bitmap equal with at least K bits, and/or
3. specifying after the bitmap, K data fields, each field possibly of variable size, the first subfield specifying the number of subfields, each subfield specifying the location of the pictures required for its reconstruction.
   In addition to these three, the following can be included in some embodiments:
4. A field or (value of the above fields) denoting a picture that is not a reference picture but needs to be kept in the display picture buffer (DPB) of AVC for at least one picture time because its presentation time does not coincide with its decode time.
5. The picture number (or delay in number of pictures) in relation to the start of the longer repetitive sequence of pictures corresponding to the first picture that guarantees that the pictures in display order from the first picture on are reconstructed. Some pictures prior to the first picture may not be reconstructed upon a channel change or random access due to direct or indirect temporal dependencies to pictures transmitted prior to the beginning of the longer repetitive sequence of pictures.
6. The maximum delay in number of pictures between transmission and display order among the pictures.

The DHCT 200 includes at least one storage device 273 for storing video streams received by the DHCT 200. A PVR application 277, in cooperation with an operating system 253 and a device driver 211, effects, among other functions, read and/or write operations to/from the storage device 273. Herein, references to write and/or read operations to the storage device 273 can be understood to include operations to the medium or media of the storage device 273. The device driver 211 is generally a software module residing in the operating system 253. The device driver 211, under management of the operating system 253, communicates with the storage device controller 279 to provide the operating instructions for the storage device 273. As conventional device drivers and device controllers are well known to those of ordinary skill in the art, further discussion of the detailed working of each will not be described further here.

The storage device 273 can be located internal to the DHCT 200 and coupled to a common bus 205 through a communication interface 275. The communication interface 275 can include an integrated drive electronics (IDE), small computer system interface (SCSI), IEEE-1394 or universal serial bus (USB), among others. Alternatively or additionally, the storage device 273 can be externally connected to the DHCT 200 via a communication port 274. The communication port 274 may be, for example, an IEEE-1394, a USB, a SCSI, or an IDE-part. In one implementation, video streams are received in the DHCT 200 via communications interface 242 and stored in a temporary memory cache (not shown). The temporary memory cache may be a designated section of DRAM 252 or an independent memory attached directly to a communication interface 242. The temporary cache is implemented and managed to enable media content transfers to the storage device 273. In some implementations, the fast access time and high data transfer rate characteristics of the storage device 273 enable media content to be read from the temporary cache and written to the storage device 273 in a sufficiently fast manner. Multiple simultaneous data transfer operations may be implemented so that while data is being transferred from the temporary cache to the storage device 273, additional data may be received and stored in the temporary cache.

Any of the described subsystems or methods of DHCT 220 can comprise an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

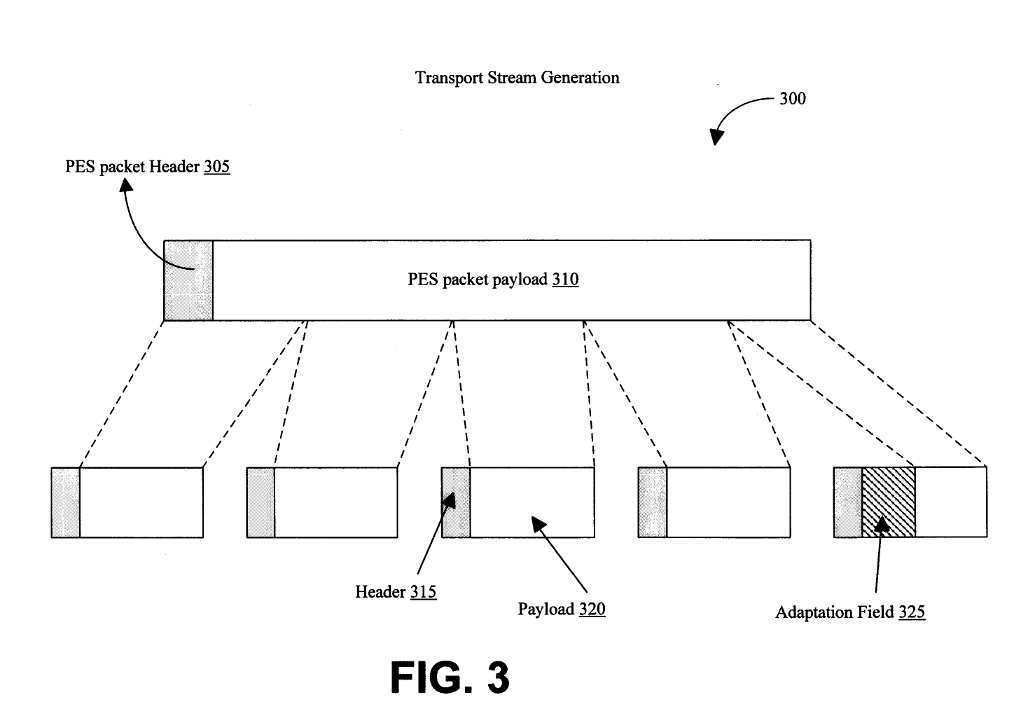

FIG. 3 is a block diagram illustrating an exemplary transport stream 300 generated by the systems and methods disclosed herein. Multiple packetized elementary streams (PES) are combined into a single stream along with synchronization information. The PES can have a fixed length packet size, which is intended for non-error free environments, easy detection of start and end frames, and easy recovery from packet loss/corruption. The PES includes aPES packet header 305 and aPES packet payload 310. The payload 310 includes data bytes taken sequentially from the original elementary stream. The PES packet can have variable or fixed size frames. For example, an entire video frame can be in one PES packet. The PES packet header 305 includes information that can be used to distinguish PES packets of various streams and also contains time stamp information. Generally, the first byte of the PES packet includes the first byte of transport packet payload. Each transport packet can contain data from one PES packet. The one PES packet can be divided among multiple transport stream (TS) packets. Each TS packet includes a packet header 315 and a payload 320 or adaptation field 325 or both. The adaptation field 325 is for sending various types of information such as a splice countdown used to indicate program clock reference and edit points. The adaptation field 325 can also be used for stuffing so that the TS-packet payload has the fixed-length TS packet.

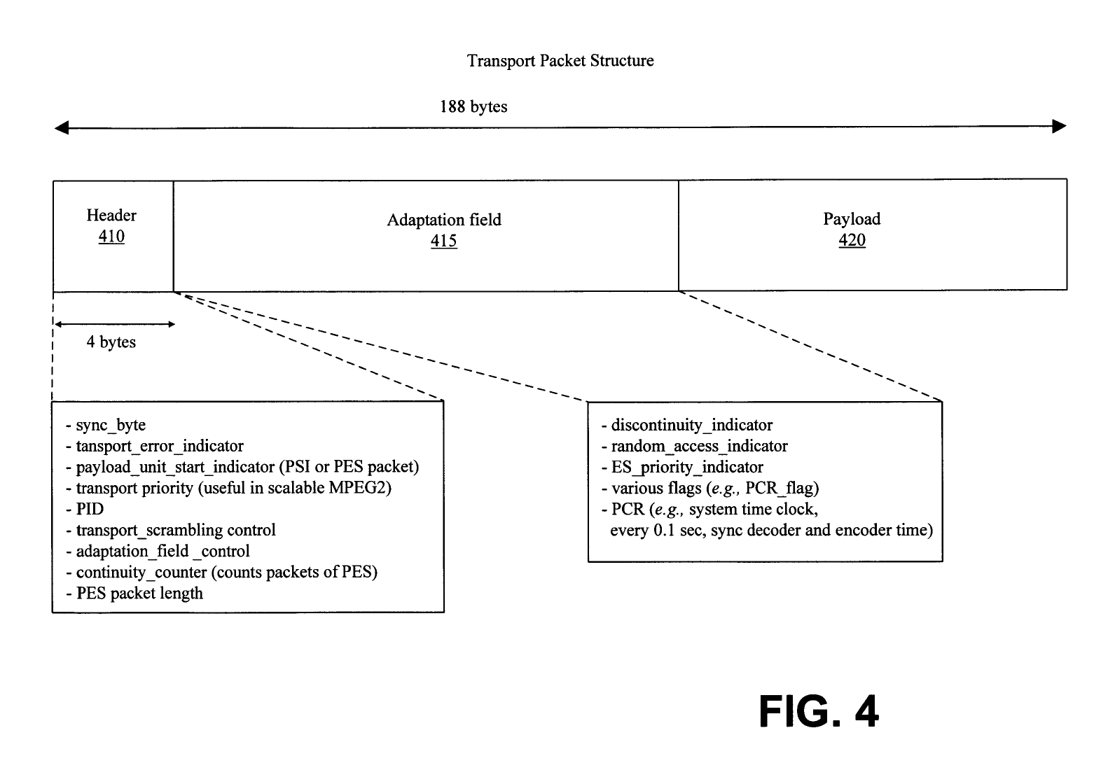

FIG. 4 is an exemplary diagram illustrating a transport packet structure. The transport structure generally includes packets that are 188 bytes, each of which are comprised of a header 410 and an adaptation field 415 or payload 420 or both. The header 410 includes a sync byte that sets the start of a transport stream packet and allows transmission synchronization, a transport error indicator that indicates the packet has an error, a payload unit start indicator that includes a program specific information (PSI) or packetized elementary stream (PES) packet, and a packet identifier (PID) that contains navigation information to find, identify and reconstruct programs. The header 410 further includes a transport scrambling control, adaptation field control, continuity counter that counts packets of PES, and PES packet length.

The PSI transport packets are used by a decoder to learn about the transport stream. The PSI transport packets can be configured to change program configuration and to achieve flexible multiplexing. The PSI includes a program association table (PAT), which contains a list of programs in the transport stream along with packet identifier (PID) for a program map table (PMT) for each program. The PMT contains the PID for each of the channels associated with a particular program. The PSI can include a network information table (NIT) that includes contents that are private and not part of the MPEG standard. The NIT can be used to provide, useful information about the physical network such as channel frequencies, service originator and service name. The PSI further includes a conditional access table (CAT) that provides details of the scrambling system in use and provides the PID values of the transport packets. The CAT should be sent when the elementary stream is scrambled.

The adaptation field 415 contains auxiliary information that is considered “helper” information, which allows for future extensions and additions to the information carried and allows other information to be carried in the adaptation field's private data. It should be noted that the auxiliary information at the transport layer is generally unencrypted and enables a video decoder to determine whether to drop a picture corresponding to the auxiliary information without having to parse a video stream. The auxiliary information enables a personal video recorder (PVR) to mark the picture to fulfill PVR functionality. Alternatively or additionally, the marked picture corresponds to video-on-demand (VOD).

The auxiliary information enables annotating pictures to separate the transport stream stored in a hard-drive of a set top box (STB) along with compressed video stream according to picture type, which includes, for example, an Intra (I) picture type and instantaneous decoding refresh (IDR) picture type. The annotated pictures in a VOD server can provide trick modes to the STB in a network. The video stream can be parsed to find the annotations corresponding to the pictures prior to decoding the video stream. The video stream can be transmitted to the hard drive or a server of the STB without decryption.

The adaptation field 415 includes a discontinuity indicator, random access indicator, ES priority indicator, and various flags for, such as, program clock reference (PCR), and PCR if the PCR flag is set, among others. The adaptation field 415 further includes a data field length. If data field length contains the value 0, then no fields after the data field length are sent. If data field length contains the value 1, then coding format information and coding type information are present in the packet. The coding format information relates to coding format used by the elementary stream carried on the packet and the coding type information relates to the elementary stream slice types. The coding type information provides information relating to the I and IDR pictures in advanced video coding (AVC), but not to the P and B pictures. Instead, the coding type information provides auxiliary information so as to determine, for example, whether a particular picture is one of the following: discardable picture, forward predicted picture, a backward predicted picture, and a bi-directional predicted picture. The discardable picture does not serve as a reference picture to reconstruct other picture. The forward predicted picture, backward predicted picture, and bi-directional predicted picture serve as reference pictures and provide hints about picture to facilitate PVR functionality (e.g., trick modes). The forward predicted pictures are predicted from one or more past reference pictures. The past picture is one with earlier display time to the current picture. The backward predicted pictures are predicted from one or more future reference pictures, which have a display time later than the current picture. The bidirectional predicted picture is predicted from at least one past reference picture and at least one future reference picture.

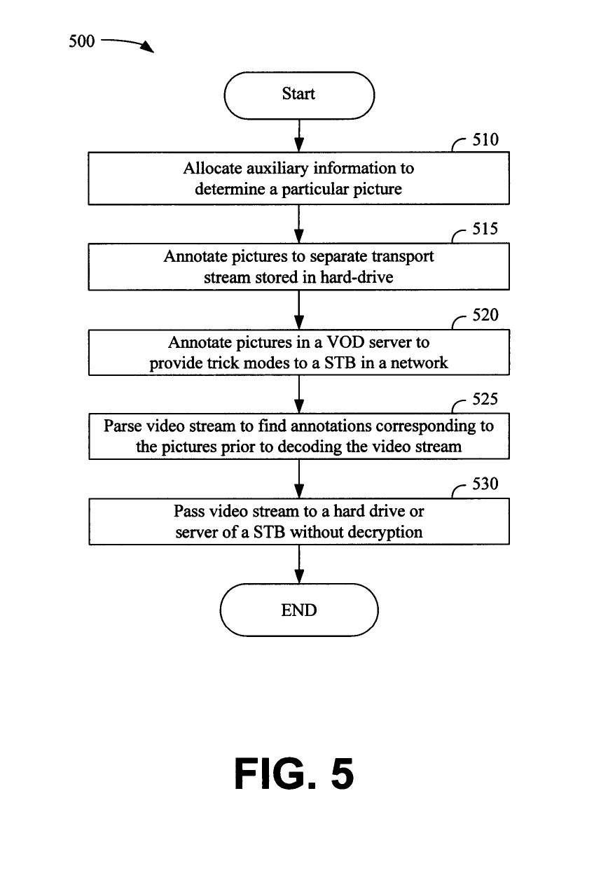

FIG. 5 is an exemplary flow diagram illustrating a process 500 for signaling characteristics of pictures' interdependencies in a video signal in subscriber television systems. Beginning with block 510, the process comprises allocating auxiliary information at a transport layer of a video program so as to determine whether a particular picture is one of the following: a discardable picture, a forward predicted picture, a backward predicted picture, and a bi-directional predicted picture.

In block 515, the process further includes annotating pictures to separate the transport stream stored in a hard-drive of a set top box (STB) along with compressed video stream according to picture type. The picture type includes one of the following: an Intra (I) picture and instantaneous decoding refresh (IDR) picture. In block 520, the pictures are annotated in a VOD server to provide trick modes to the STB in a network. In block 525, the video stream is parsed to find the annotations corresponding to the pictures prior to decoding the video stream. In block 530, the video stream is passed to the hard drive or a server of the STB without decryption.

Conditional language, such as, among others, “can,” “could,” “might,” or “may,” unless specifically stated otherwise, or otherwise understood within the context as used, is generally intended to convey that certain embodiments could include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Any process descriptions or blocks in flow charts should be understood as representing modules, segments, or portions of code which include one or more executable instructions for implementing specific logical functions or steps in the process, and alternate implementations are included within the scope of the preferred embodiment of the present disclosure in which functions may be executed out of order from that shown or discussed, including substantially concurrently or in reverse order, depending on the functionality involved, as would be understood by those reasonably skilled in the art of the present disclosure.

It should be emphasized that the above-described embodiments of the present disclosure, particularly, any “preferred embodiments” are merely possible examples of implementations, merely setting forth a clear understanding of the principles of the disclosures. Many variations and modifications may be made to the above-described embodiments of the disclosure without departing substantially from the spirit of the principles of the disclosure. All such modifications and variations are intended to be included herein within the scope of the disclosure and present disclosure and protected by the following claims.

Therefore, having thus described the disclosure, at least the following is claimed:

1. A method for signaling characteristics of pictures' interdependencies in a video signal in subscriber television systems, said method comprising the steps of:
providing a transport layer of a video program;
allocating auxiliary information at the transport layer to determine whether a picture is one of the following: a discardable picture, a forward predicted picture, a backward predicted picture, and a bidirectional predicted picture, the auxiliary information at the transport layer being unencrypted and transmitted as part of private data or an adaptation field; and
determining whether to drop the picture corresponding to the auxiliary information without having to parse a video stream.

2. The method of claim 1, wherein the auxiliary information enables a personal video recorder (PVR) to mark the picture to fulfill PVR functionality.

3. The method of claim 2, wherein the marked picture corresponds to video-on-demand (VOD).

4. The method of claim 1, further comprising annotating the picture to separate the files stored in a hard-drive of a set top box (STB) along with compressed video stream according to a picture type, the picture type including one of the following: an Intra (I) picture and instantaneous decoding refresh (IDR) picture.

5. The method of claim 1, further comprising annotating the picture in a VOD server to provide trick modes to a STB in a network.

6. The method of claim 1, further comprising if the picture is determined not to be dropped, parsing the video stream to find annotations corresponding to the picture prior to decoding the video stream.

7. The method of claim 1, further comprising passing the video stream to a hard drive or a server of a STB without decryption.

8. A set top box for processing characteristics of pictures' interdependencies in a video signal in subscriber television systems, the set top box comprising:
a channel decoder that receives a channel from a network and generates a transport stream;
a transport decoder that receives the transport stream and decodes auxiliary information at a transport layer of a video program to determine whether a picture is one of the following: a discardable picture, a forward predicted picture, a backward predicted picture, and a bi-directional predicted picture, the auxiliary information at the transport layer being unencrypted and transmitted as part of private data or an adaptation field; and
a video decoder that determines whether to drop the picture corresponding to the auxiliary information without having to parse a video stream.

9. The set top box of claim 8, wherein the auxiliary information enables a personal video recorder (PVR) to mark the picture to fulfill PVR functionality.

10. The set top box of claim 9, wherein the marked picture corresponds to video-on-demand (VOD).

11. The set top box of claim 8, wherein the picture is annotated to separate the transport stream stored in a hard-drive of a set top box (STB) along with compressed video stream according to a picture type, the picture type including one of the following:
an Intra (I) picture and instantaneous decoding refresh (IDR) picture.

12. The set top box of claim 8, wherein the picture is annotated in a VOD server to provide trick modes to a STB in a network.

13. The set top box of claim 8, wherein if the picture is determined not to be dropped, the transport decoder is operable to parse the video stream to find annotations corresponding to the picture prior to decoding the video stream.

14. The set top box of claim 8, wherein the transport decoder is operable to pass the video stream to a hard drive or server of a STB without decryption.

15. A computer-readable medium having a computer program for signaling characteristics of pictures' interdependencies in a video signal in subscriber television systems, said computer-readable medium comprising:
logic configured to provide a transport layer of a video program;
logic configured to allocate auxiliary information at the transport layer to determine whether a picture is one of the following: a discardable picture, a forward predicted picture, a backward predicted picture, and a bidrectional predicted picture, the auxiliary information at the transport layer being unencrypted and transmitted as part of private data or an adaptation field; and
logic configured to determine whether to drop the picture corresponding to the auxiliary information without having to parse a video stream.

16. The computer readable medium of claim 15, wherein the auxiliary information enables a personal video recorder (PVR) to mark the picture to fulfill PVR functionality.

17. The computer readable medium of claim 16, wherein the marked picture corresponds to video-on-demand (VOD).

18. The computer readable medium of claim 15, further comprising logic configured to annotate the picture to separate the files stored in a hard-drive of a set top box (STB) along with compressed video stream according to a picture type, the picture type including one of the following: an Intra (I) picture and instantaneous decoding refresh (IDR) picture.

19. The computer readable medium of claim 15, further comprising logic configured to annotate the picture in a VOD server to provide trick modes to a STB in a network.

20. The computer readable medium of claim 15, further comprising logic configured to parse the video stream to find annotations corresponding to the picture prior to decoding the video stream after the picture is determined not to be dropped.
